(19) United States
(12) Patent Application Publication
(10) Pub. No.: US 2020/0048951 A1
(43) Pub. Date: Feb. 13, 2020

(54) Drone Delivery Lock Box

(71) Applicant: Eric Herschap, Orange Grove, TX (US)

(72) Inventor: Eric Herschap, Orange Grove, TX (US)

(21) Appl. No.: 16/539,744

(22) Filed: Aug. 13, 2019

Related U.S. Application Data
(60) Provisional application No. 62/718,354, filed on Aug. 13, 2018.

(51) Int. Cl. E05G 1/10; G06Q 10/08; G07C 9/00; E05G 1/04; E05G 1/024; E05G 1/026; B64C 39/02; B64D 1/02

(52) U.S. Cl. CPC E05G 1/10; G06Q 10/0833; G07C 9/00166; G07C 9/00896; E05G 1/04; B64C 2201/128; E05G 1/026; B64C 39/024; B64D 1/02; G07C 2009/0092; B64C 2201/027; E05G 1/024

(57) ABSTRACT

A disclosed app includes locating a closest lock box coordinates to a parcel recipient, locking in the coordinates into the drone and sending an email or text to the parcel recipient with a box location and an electronic lock code and a time of the parcel delivery, flying the drone with the parcel to descend over the lock box within three feet for sensing the drone with a matching frequency for opening a top lock box doors, delivering the parcel by drop releasing the parcel into the lock box via the top lock box doors and closing the top lock box doors once package has been lowered into the lock box, notifying the parcel recipient that the parcel has been delivered and receiving the electronic lock code at the lock box and opening a lock box side door via the electronic lock code to retrieve the parcel.

### CROSS REFERENCE

The present non-provisional patent application claims priority to the provisional patent application U.S. Ser. No. 62/718,354 filed Aug. 13, 2018 under the title Drone Delivery Box by Eric Herschap and is incorporated herein by reference in its entirety.

### BACKGROUND OF THE INVENTION

### Field of Invention

The present invention relates to a drone delivery box for receiving packages.

### Description of Related Art

Package delivery is a common service provided by many shippers. The shipping usually relates to retail shipping orders or any other commercial orders to both residential and commercial locations. With respect to residential delivery, many of the package carriers deliver packages and may leave the package at the doorstep of the recipient. This practice has caused a serious problem with the theft of these packages by thieves. One way of combating theft is to provide secure lock boxes that house the package for receipt by the recipient. Another drawback to the package delivery system relates to navigating through the traffic on delivery routes. One solution to avoid traffic delays relates to the use of drones for package delivery. Drones can be programmed to locate a particular residence and allow the dropping of the package at the doorway of the individual. However, again one drawback to this delivery method is the risk of theft.

### SUMMARY OF THE DISCLOSURE

A disclosed box for drone drop off includes an enclosure, a secured side access door for a user to access an inside of the enclosure, a first top half cover and second top half cover, where the top covers together enable a top access into the enclosure for package delivery therein, a package plate under the first and second half covers, a spring support system supporting the package plate within the enclosure and a sensor configured to detect the proximity of the drone to enable an opening of the top half covers.

A disclosed computer program product, also known as an app or application includes a computer readable medium having computer useable code executable to perform operations for secure drone delivery to and holding, the operations of the computer program product comprising locating a closest lock box coordinates to a parcel recipient via an address of a parcel recipient provided by a drone shipping company, locking in the coordinates into the drone and sending an email or text to the parcel recipient with a box location and an electronic lock code and a time of the parcel delivery, flying the drone with the parcel to descend over the lock box within three feet for sensing the drone with a matching frequency for opening a top lock box doors, delivering the parcel by drop releasing the parcel into the lock box via the top lock box doors and closing the top lock box doors once package has been lowered into the lock box, notifying the parcel recipient that the parcel has been delivered and receiving the electronic lock code at the lock box and opening a lock box side door via the electronic lock code to retrieve the parcel secured and held in the lock box.

Other aspects and advantages of embodiments of the disclosure will become apparent from the following detailed description, taken in conjunction with the accompanying drawings, illustrated by way of example of the principles of the disclosure.

### BRIEF DESCRIPTION OF DRAWINGS

FIG. 1 depicts a first embodiment of a drone box according to an embodiment of the present disclosure.

FIG. 2 depicts a method for a drone lock box in accordance with an embodiment of the present disclosure.

Throughout the description, same and similar reference numbers may be used to identify same and similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the terms ‘lock box,’ and ‘drone box,’ are used synonymously.

The present invention relates to a lock box developed to receive and to accommodate secure drone delivery and receipt of packages. This particular lock box is assembled in a manner to allow for a top cover to open and receive a package within an underlying container within the enclosure of the box. Once placed in this box, the lid is closed automatically and electronically sealed until a recipient opens the box to retrieve the enclosed package.

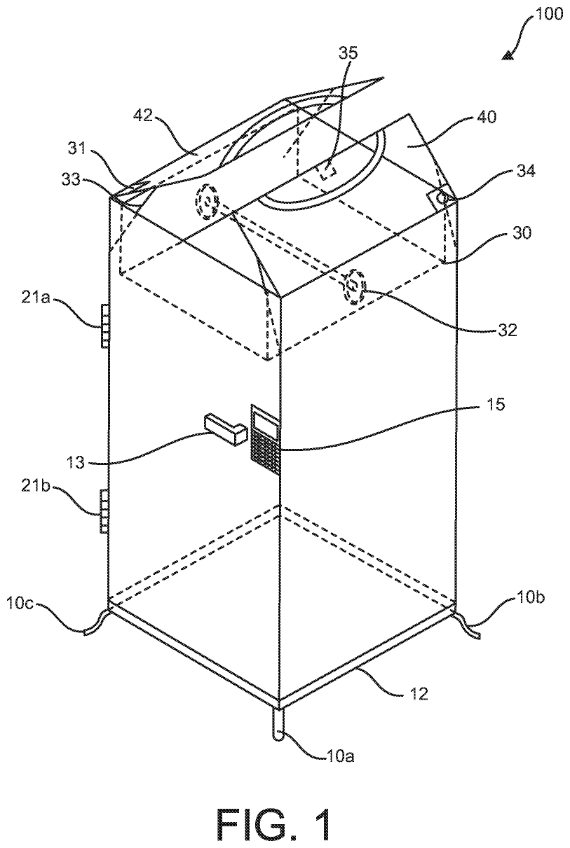

In reference to FIG. 1, a drone lock box adapted to receive packages is depicted. The lock box enclosure 100 according to an embodiment of the present disclosure includes a first top cover 42 and a second top cover 40 as shown. These covers 40,42 open automatically through the use of a sensor 31. An actuator 33 is shown on one side that enables the opening of the first top cover 42 and an additional actuator is available for the top cover 40. The sensor 31 detects the proximity of an approaching drone that initiates the opening of the top covers 40 and 42 upon activation. The covers 40,42 are normally in a locked position when not open for delivery purposes. An electronic controlled lock 35 is provided on the top cover 40 that locks the top cover when in a closed position. Further shown is a GPS module 34 that provides data to the approaching drone related to location parameters.

Other features on the box 100 include a package plate 30 within the enclosure 100 supported by a spring assembly 32. Once a package is placed in the box on the package plate 30, the package plate 30 moves to a lower position for access by the user. A door is provided with a handle 13 and an electronic keypad lock 15. The keypad lock 15 gives the user access to the interior or enclosure of the box 100 after the delivery has been made. The access code may be electronically sent to the recipient. Hinges 21a, 21b hold the door in place for user access. Another feature shown in FIG. 1 includes anchor feet 10a, 10b, 10c. An additional anchor foot further, not shown, is at the remaining corner of the box 100 although not shown in FIG. 1.

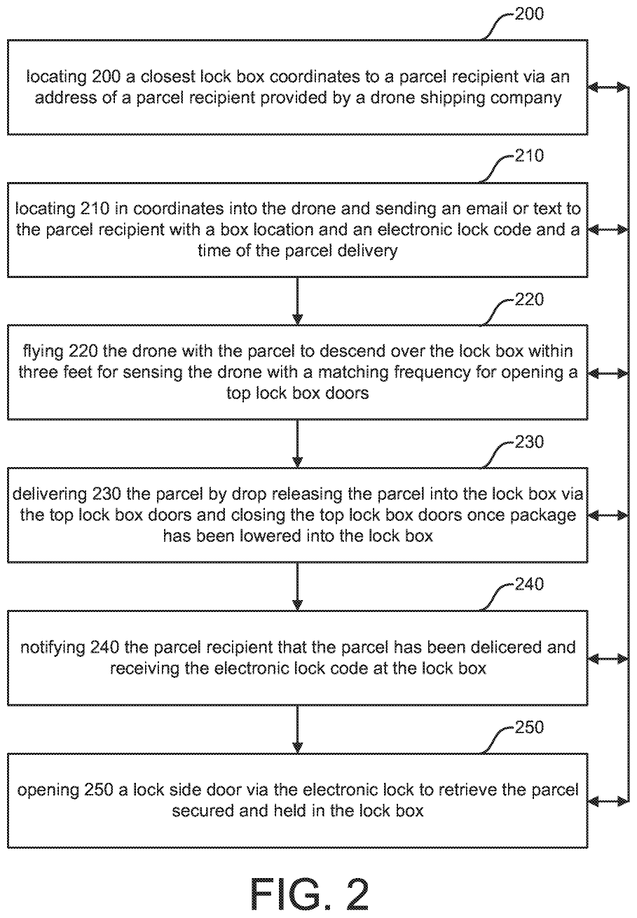

FIG. 2 depicts a method for a drone lock box in accordance with an embodiment of the present disclosure. The drone shipping company types in the address of the parcel recipient which brings up the closest dronebox site to the recipient. It then locks in the GPS coordinates into the drone and sends an email or text to the recipient with box location and the electronic lock code, with time of the parcel drop being made. The drone then flies package to dronebox of GPS coordinates begins to descend over dronebox. Once it is within 3 Ft. the infrared sensor, senses the drone with matching frequency, and begins to open the actuated lock to open the parcel doors. The drone then releases the package once it is within its drop limits into the dronebox. The dronebox then closes the parcel doors once package has been lowered into the dronebox and locks the parcel doors. Recipient is notified that package has been dropped off and to use the code on the keypad/NFC of the dronebox that the parcel was dropped off. The recipient then uses the code to open the package doors to retrieve their packages safe and sound from fear of thieves, and weather.

Steps of the computer program product or app include locating 200 a closest lock box coordinates to a parcel recipient via an address of a parcel recipient provided by a drone shipping company, locking 210 in the coordinates into the drone and sending an email or text to the parcel recipient with a box location and an electronic lock code and a time of the parcel delivery, flying 220 the drone with the parcel to descend over the lock box within three feet for sensing the drone with a matching frequency for opening a top lock box doors, delivering 230 the parcel by drop releasing the parcel into the lock box via the top lock box doors and closing the top lock box doors once package has been lowered into the lock box, notifying 240 the parcel recipient that the parcel has been delivered and receiving the electronic lock code at the lock box and opening 250 a lock box side door via the electronic lock code to retrieve the parcel secured and held in the lock box.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A box for drone drop off comprising:
an enclosure having global location coordinates discoverable by a drone shipping company for a package recipient;
a secured side access door for a user to access an inside of the enclosure to receive, secure, hold and enable retrieval of the package;
a first top half cover and second top half cover, where the top covers together enable a top access into the enclosure for package drop release delivery therein;
a package plate configured to receive the package under the first and second half top covers;
a spring support system supporting the package plate within the enclosure;
a sensor configured to detect the proximity of the drone to enable an opening of the top half covers; and
an electronic processor configured to communicate with the drone and with the drone shipping company regarding the package delivery and the package receipt.

2. The box of claim 1, wherein the spring support system is configured to suspend lighter packages and to drop heavier packages further down into the enclosure.

3. The box of claim 1, wherein the spring support system is configured to allow multiple packages to be received into the enclosure via dropping a package plate further down into the enclosure.

4. The box of claim 1, wherein the lock box enclosure comprises a metallic alloy configured to shield against an electromagnetic pulse.

5. The box of claim 1, further comprising an electronic lock configured to secure the first and the second top half covers.

6. The box of claim 1, further comprising a electromagnetic transceiver configured to communicate with the user via email, text and with a GPS (Global Positioning System) module at the box.

7. The box of claim 1, further comprising a GPS module configured to communicate with an electromagnetic transceiver at the box and with the drone.

8. The box of claim 1, wherein the secured side access door further includes an electronic keypad configured to accept a code to enable opening the door.

9. The box of claim 1, further comprising at least 4 anchor feet attached to the four bottom corners of the enclosure to electrically isolate the enclosure from a receiving surface.

10. The box of claim 1, further comprising at least one actuator for each top half cover, each actuator configured to automatically open and shut a respective top half cover based on an electronic signal.

11. The box of claim 1, further comprising a failsafe lock on the top half covers and on the side access door, the failsafe lock configured to lock down the enclosure in the event of a perceived threat to the enclosure.

12. The box of claim 1, further comprising at least one infrared transceiver configured to enable an opening of the top half covers via a signal from the GPS module.

13. A computer program product comprising a computer readable medium having computer useable code executable to perform operations for secure drone delivery to and holding, the operations of the computer program product comprising:
locating a closest lock box coordinates to a parcel recipient via an address of a parcel recipient provided by a drone shipping company;
locking in the coordinates into the drone and sending an email or text to the parcel recipient with a box location and an electronic lock code and a time of the parcel delivery;
flying the drone with the parcel to descend over the lock box within three feet for sensing the drone with a matching frequency for opening a top lock box doors;
delivering the parcel by drop releasing the parcel into the lock box via the top lock box doors and closing the top lock box doors once package has been lowered into the lock box;
notifying the parcel recipient that the parcel has been delivered and receiving the electronic lock code at the lock box; and
opening a lock box side door via the electronic lock code to retrieve the parcel secured and held in the lock box.

14. The computer program product of claim 13, further comprising entering the electronic lock code into a keypad on the lock box side door.

15. The computer program product of claim 13, further comprising dropping the parcel toward a bottom of the lock box on a spring loaded package plate.

16. The computer program product of claim 13, further comprising sensing the drone with a matching frequency via an electromagnetic communication.

17. The computer program product of claim 13, further comprising sensing the drone with an infrared communication.

18. The computer program product of claim 13, further comprising an electronic lock code for another parcel.

19. The computer program product of claim 13, further comprising receiving another parcel from another recipient identified by another electronic lock code.

20. The computer program product of claim 13, further comprising another package plate reserved for another parcel and another parcel recipient.
